(19) United States
(12) Patent Application Publication
(10) Pub. No.: US 2002/0034260 A1
(43) Pub. Date: Mar. 21, 2002

(54) Adaptive predistortion transmitter

(75) Inventor: Wang Rae Kim, Kyungki-Do (KR)

Correspondence Address: FLESHNER & KIM, LLP, P.O. Box 221200, Chantilly, VA, 20153-1200, US

(73) Assignee: LG Electronics Inc.

(21) Appl. No.: 09/951,527

(22) Filed: Sep. 14, 2001

(30) Foreign Application Priority Data
Sep. 15, 2000 (KR) 54187/2000

(51) Int. Cl. H04L 25/03; H04L 27/04; H04K 1/02; H04L 27/12; H04L 25/49; H04L 27/20

(52) U.S. Cl. 375/296; 375/295; 375/297

(57) ABSTRACT

An adaptive predistortion transmitter is disclosed. The transmitter includes a predistortion unit that distorts a digital input signal to have a non-linear characteristic opposite to that of the whole transmitter. A radio frequency converter converts an output signal of the predistortion unit into a radio frequency signal and an HPA amplifies the radio frequency converter. An error detector detects a non-linear characteristic change of the whole transmitter, by comparing the digital input signal and the output signal of the HPA, and controls an operation of the predistortion unit. The predistortion unit is implemented in consideration of the non-linear characteristic of the whole transmitter, including the up-converter and the HPA. Thus, the non-linear characteristic of the transmitter can be effectively improved. In addition, since the predistortion unit and a direct IF up-converter are implemented in one chip, the design structure of the whole transmitter can be simplified.

### BACKGROUND OF THE INVENTION

1. Field of the Invention

The present invention relates to a transmitter for a digital method and, more particularly, to an adaptive predistortion transmitter using an adaptive predistorter.

2. Background of the Related Art

Radio communication is rapidly changing from an analog method to a digital method because the digital method shows a better speech quality than that of the analog method and can transmit a large quantity of voice data and image. Commercially used digital modulation methods include Code Division Multiple Access (CDMA) and a Time Division Multiple Access (TDMA).

FIG. 1 is a schematic block diagram of a transmitter for a digital method in accordance with the background art. A direct digital IF up-converter 101 converts digital input signals (I, Q) modulated by the CDMA or the TDMA method into a signal of intermediate frequency band. A digital/analog converter (DAC) 102 converts a digital input signal of intermediate frequency band into an analog signal. A low pass filter (LPF) 103 filters the analog signal produced by the DAC 102 and outputs it to an up-converter 104. The up-converter 104 synthesizes an output signal of the LPF 103 and an oscillation signal of a local oscillator (LO) (not shown) and generates a radio frequency signal. A high power amplifier (HPA) 105 amplifies the radio frequency signal outputted from the up-converter 104 to a predetermined level and transmits it.

The HPA 105 is typically implemented with active elements having a non-linear characteristic, so that the output signal of the HPA 105 inevitably includes a distortion component. Thus, in order to improve the non-linear characteristics (AM-AM, AM-PM) of the HPA 104, various linearization techniques have been proposed. Representative linearization techniques include a feedforward, a predistortion, an envelope correction, and a bias compensation.

The non-linear characteristic of the HPA 105 varies depending on time or the external environment (i.e., a temperature or a bias, etc). The above described linearization techniques fail to effectively compensate the non-linear characteristics (AM-AM, AM-PM) of the power amplifier 105, which vary depending on time and the external environment (the temperature, or the bias). In an effort to solve this problem, an adaptive predistortion linearizer is adopted which changes the non-linear characteristic of a predistorter according to the variation of the non-linear characteristic of the power amplifier.

FIG. 2 is a schematic block diagram of a transmitter (an adaptive predistortion transmitter) adopting an adaptive predistortion linearizer in accordance with the background art. The conventional adaptive predistortion transmitter includes an adaptive predistortion linearizer 200 in the digital transmitter of FIG. 1.

A divider 201 divides a digital input signal into the first and the second paths 10 and 11. A directional coupler 202 samples an output signal of the HPA 105 and feeds it back to the adaptive predistortion linearizer 200.

The adaptive predistortion linearizer 200 includes (1) a predistorter 21 for distorting an output signal of the up-converter 104 so as to have the opposite characteristic to the non-linear characteristic of the HPA 105; (2) a delay unit 22 for delaying the digital input signals (I, Q) divided by the divider 201; (3) a down-converter 23 for converting the output signal of the HPA 105 which has been feedback through the directional coupler 202 into an intermediate frequency signal; (4) an analog/digital converter (ADC) 24 for converting the output signal of the down-converter 23 into a digital signal; and (5) an error detector 25 for detecting an error between the output signals of the delay unit 22 and the ADC 24 and controlling the non-linear characteristic of the predistorter 21.

The operation of the background art adaptive predistortion transmitter will now be explained. The digital input signals (I, Q) are divided into the first path 10, a main path, and the second path 11, a sub path, by the divider 201. The digital input signals (I, Q) on the first path are converted into a signal of intermediate frequency band by the direct digital IF up-converter. The converted analog signal is converted into a radio frequency signal by up converter 104 after passing through the DAC 102 and LPF 103. The radio frequency signal is distorted by the predistorter 21 so as to have the opposite characteristics to the non-linear characteristics (i.e., gain and phase) of the HPA 105. After being predistorted, the signal is conveyed to the HPA 105. HPA 105 amplifies the output signal of the predistorter 21 to a predetermined level, so that the distortion component due to the non-linear characteristics of the HPA 105 is compensated, and outputs the amplified signal.

Error detector 25 compares the digital input signals (I, Q) divided into the second path 11 and the output signal of the HPA 105 feedback through the directional coupler 202. Based on this comparison, the error detector 25 controls the non-linear characteristic of the predistorter 21 according to an error (the gain and the phase) of the two signals. The error detector controls the predistorter's 21 non-linear characteristic to compensate the non-linear characteristic (AM-AM, AM-PM) of the HPA 105, which varies depending on time or an external environment (a temperature or a bias).

The background art adaptive predistortion transmitter includes the predistorter at the front end of the HPA to improve the non-linear characteristics of the HPA. However, the background art adaptive predistortion transmitter has a problem. Since the predistorter is positioned between the up-converter and the HPA, it fails to improve the non-linear characteristics of the up-converter 104. Also, to compensate the non-linear characteristics (AM-AM, AM-PM) of the HPA, the predistorter should be constructed separately, which makes a hardware block for improving the linearity of the power amplifier complicated.

### SUMMARY OF THE INVENTION

An object of the invention is to solve at least the above problems and/or disadvantages and to provide at least the advantages described hereinafter.

An object of the present invention is to provide an adaptive predistortion transmitter that is capable of effectively improving a non-linear characteristic of the whole transmitter.

Another object of the present invention is to provide an adaptive predistortion transmitter that is capable of simplifying the construction of a transmitter by implementing a linearizer in a direct digital IF up-converter.

To achieve the above objects in whole or in part, there is provided an adaptive predistortion transmitter including: a predistortion unit for distorting a digital input signal so as to have the opposite characteristic to the non-linear characteristic of the whole transmitter; a radio frequency converter for converting an output signal of the predistorter into a radio frequency signal; an HPA for amplifying an output signal of the radio frequency converter; and an error detector for detecting non-linear characteristic changes of the whole transmitter according to a comparison between the digital input signal and the output signal of the HPA and controlling an operation of the predistorter.

The objects of the present invention may be achieved in whole or in part by an adaptive predistortion transmitter, including a predistortion unit that predistorts a digital input signal, based on a control signal; a radio frequency converter that converts the predistorted digital input signal into a radio frequency signal; and an error signal detector that adaptively modulates the control signal based on the digital input signal and the radio frequency signal.

The objects of the present invention may be further achieved in whole or in part by an adaptive predistortion transmission method, including predistorting a digital input signal based on a control signal; converting the predistorted digital input signal into a radio frequency signal; and adaptively modulating the control signal based on the digital input signal and the radio frequency signal, wherein the control signal is modulated to vary the predistortion applied to the digital input signal so that a non-linear characteristic of the radio frequency signal, introduced by the conversion to radio frequency, is cancelled by signal addition in a subsequent portion of the radio frequency signal.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 illustrates a schematic block diagram of a transmitter for a digital method in accordance with the background art;

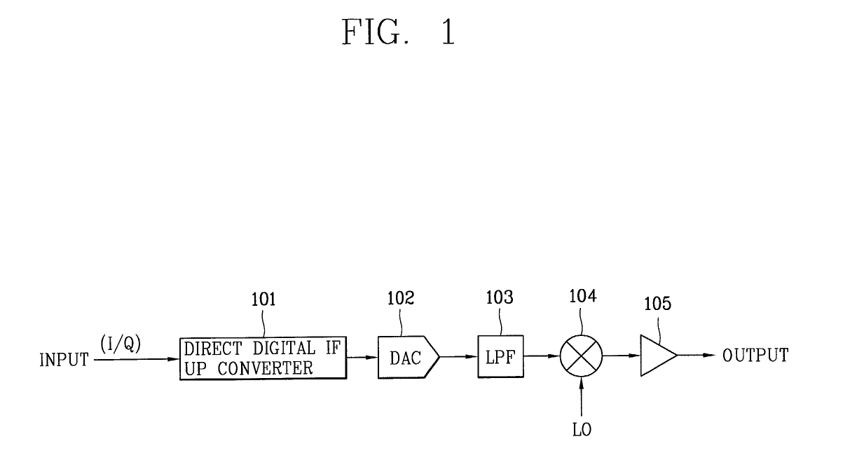

FIG. 2 illustrates a schematic block diagram of a transmitter (an adaptive predistortion transmitter) for the digital method adopting an adaptive predistortion linearizer in accordance with the background art;

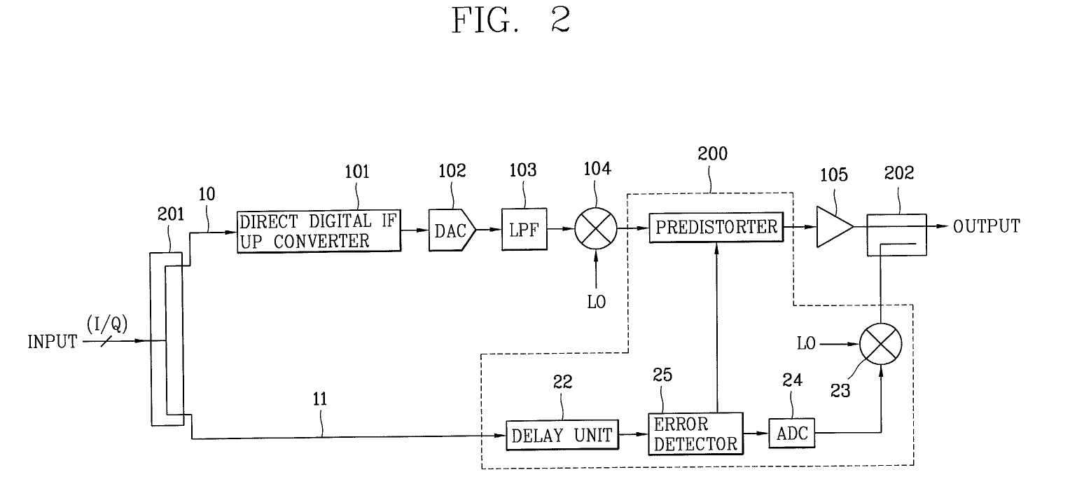

FIG. 3 illustrates a schematic block diagram of an adaptive predistortion transmitter adopting an adaptive predistortion linearizer in accordance with a preferred embodiment of the present invention;

FIG. 4 illustrates a detailed view of the predistorter of FIG. 3 in accordance with the preferred embodiment of the present invention; and

FIG. 5 illustrates a schematic block diagram of the predistorter of FIG. 3 in accordance with another preferred embodiment of the present invention.

### DETAILED DESCRIPTION OF PREFERRED EMBODIMENTS

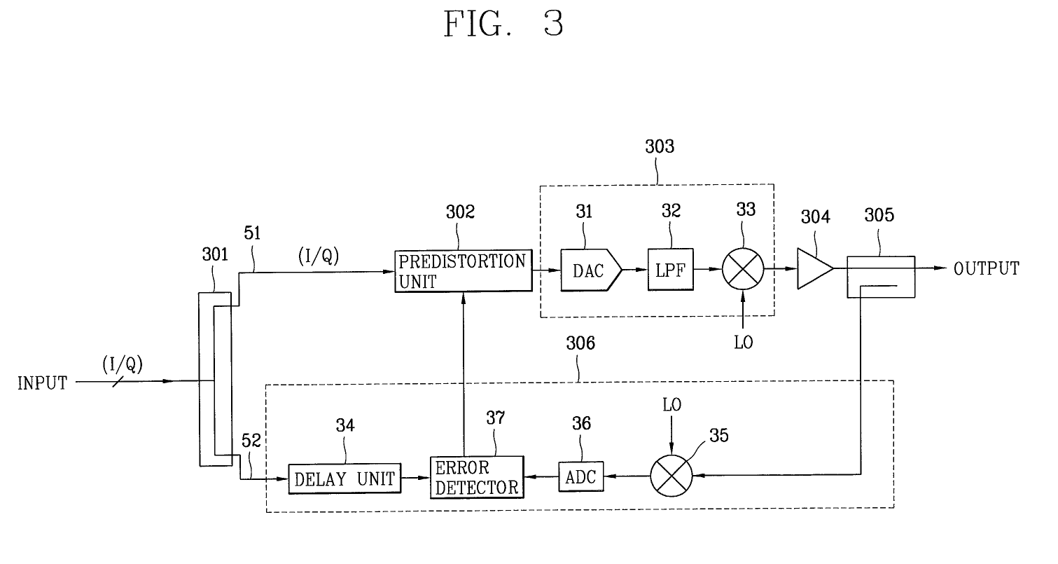

FIG. 3 is a schematic block diagram of an adaptive predistortion transmitter adopting an adaptive predistortion linearizer in accordance with a preferred embodiment of the present invention. The adaptive predistortion transmitter of the present invention includes (1) a predistortion unit 302 for distorting digital input signals (I, Q) so as to be opposite to the non-linear characteristic of the whole transmitter; (2) a radio frequency converter 303 for converting an output signal of the predistortion unit 302 into an analog signal and converting the analog signal to a radio frequency signal; (3) an HPA 304 for amplifying an output signal of the radio frequency converter 303; and (4) an error detector 306 for detecting an error between the digital input signals (I, Q) and the output signal of the HPA 304, feedback through a directional coupler 305, and controlling a distortion operation of the predistortion unit 302.

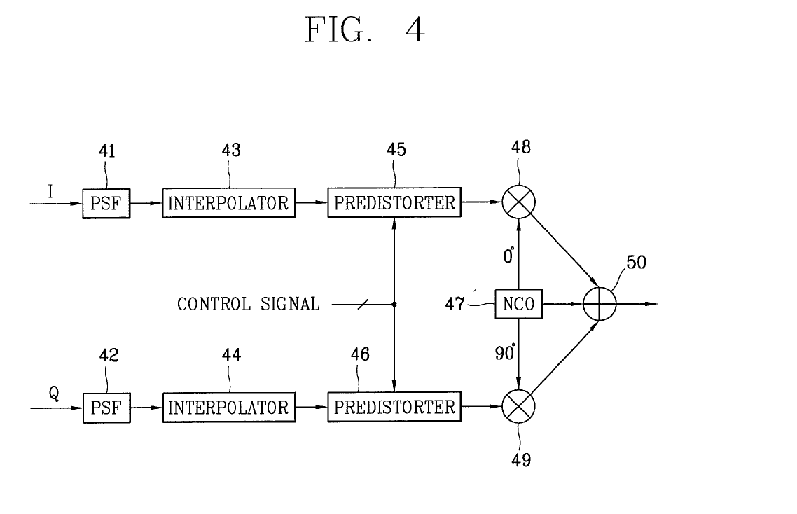

FIG. 4 is a detailed view of a predistorter 302 of FIG. 3 in accordance with the preferred embodiment of the present invention. The predistortion unit 302 includes pulse shaping filters (PSF) 41 and 42 that sample the digital input signals I and Q, respectively. Interpolators 43 and 44 interpolate the output signals of the PSFs 41 and 42, respectively. Predistorters 45 and 46 distort the output signals of the interpolators 43 and 44, respectively, so as to be opposite to the non-linear characteristic of the whole transmitter. Up-converters 48 and 49 convert the output signals of the predistorters 45 and 46, respectively, into intermediate frequency signals, according to an oscillation signal of a numerically controlled oscillator (NCO) 47. Adder 50 synthesizes the output signals of the up-converters 48 and 49. In this respect, the portion except the predistorters 45 and 46 is the direct digital IF up-converter.

The radio frequency converter 303 includes a digital/analog converter (DAC) 31 for converting the output signal of the predistortion unit 302 into an analog signal. A low pass filter (LPF) 32 filters the output signal of the DAC 31. Up-counter 33 mixes the output signal of the LPF 32 with an oscillation signal outputted from a local oscillator (LO) (not shown) and converts it into a radio frequency signal.

The error signal detector 306 includes a delay unit 34 that delays the input digital signals (I, Q). Down-converter 35 mixes the output signal of the HPA 305, feedback from the directional coupler 305, with the LO oscillation signal and converts it into an intermediate frequency signal. Analog/digital converter (ADC) 36 converts the intermediate frequency signal outputted from the down-converter 35 into a digital signal. Error detector 37 compares the output signals of the delay unit 34 and the ADC 36 to detect a change of the non-linear characteristic of the whole transmitter.

The operation of the adaptive predistortion linearizer will now be explained with reference to the accompanying drawings. The digital input signals (I, Q) are divided into two paths by the divider 301. The first path 51 is a main path for transmitting the input digital signals (I, Q) and the second path 52 is a sub path for detecting a change of the non-linear characteristic of the whole transmitter (for example, the up-converter and the HPA).

The digital input signals (I, Q) of the first path 51 are distorted to have the opposite characteristic to the non-linear characteristic of the whole transmitter by the predistortion unit 302 and converted into intermediate frequency signals. That is, as shown in FIG. 4, the PSFs 41 and 42 of the predistortion unit 302 sample the digital input signals I and Q, respectively. Thereafter, the digital input signals I and Q sampled by the PSFs 41 and 42 are interpolated by interpolators 43 and 44, respectively. Since the predistorters 45 and 46 store an initial value, which is the opposite to the non-linear characteristic of the transmitter (the up-converter and the HPA), as a higher degree function or in a look-up table form, they distort the outputs of the interpolators 43 and 44 using the initial value. The outputs of the predistorters 45 and 46 are mixed with oscillation signals of different phases, outputted from the NCO 47, by up-converters 48 and 49 and converted into intermediate frequency signals. Then, adder 50 synthesizes the output signals of the up-converters 48 and 49 and outputs an intermediate frequency signal.

Once the intermediate frequency signal is generated, the frequency converter 303 converts it into an analog signal and then converts the analog signal into a radio frequency signal. In other words, the DAC 31 of the frequency converter 303 converts the intermediate frequency signal outputted from the predistortion unit 302 into an analog signal, the converted analog signal sequentially passes through the LPF 32, and the up-converter 33 converts the filtered analog signal into the radio frequency signal. Then, HPA 304 amplifies the radio frequency signal outputted from the frequency converter 303 to a predetermined level and outputs it.

Since the non-linear characteristics of the whole transmitter (the up-converter and the HPA) vary depending on time or external environment (a temperature or a bias), the error detector 306 detects the non-linear characteristic variation of the whole transmitter and changes a coefficient of the high degree functions of the predistorters 45 and 46 or a value of the look-up table. Digital input signals I and Q on the second path 52 are delayed for a predetermined time by the delay unit 34. The output signal of the HPA 304, feedback through the directional coupler 305, is converted into a digital signal by down-converter 35 and the ADC 36. The error detector 37 compares the output signals of the delay unit 34 and the ADC 36, detects a change of the non-linear characteristic of the up-converter 33 and the HPA 304, and adaptively controls the predistorters 45 and 46 of the predistortion unit 302.

Accordingly, the predistorters 45 and 46 can effectively compensate the non-linear characteristic of the up-converter 33 as well as the non-linear characteristic of the HPA 304 according to time or external environment (the temperature or the bias). The predistortion unit 302 accomplishes this by updating the coefficient of the high degree function or the value of the look-up table, according to the control signal of the error detector 37.

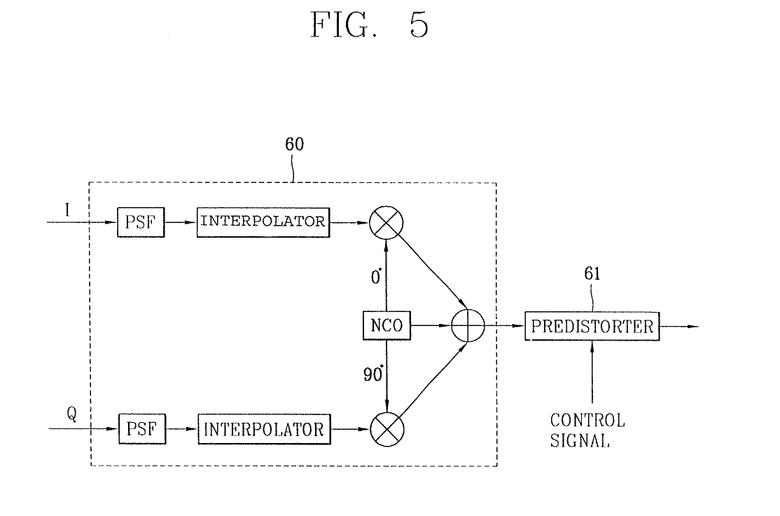

The present invention is not limited to the predistortion unit illustrated in FIG. 4. For example, a predistorter 61 may be connected at the rear end of the direct IF up-converter 60 as shown in FIG. 5.

As so far described, according to the adaptive predistortion transmitter of the present invention, the predistortor is implemented in consideration of the non-linear characteristic of the whole transmitter including the up-converter as well as the HPA. Thus, the non-linear characteristic of the transmitter can be effectively improved.

In addition, since the predistorter and the direct IF up-converter are implemented in one chip, the design structure of the whole transmitter can be simplified.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. An adaptive predistortion transmitter, comprising:
a predistortion unit that distorts a digital input signal to have an opposite characteristic to a non-linear characteristic of the whole transmitter;
a radio frequency converter that converts an output signal of the predistortion unit into a radio frequency signal;
an HPA that amplifies the radio frequency signal; and
an error detector that detects a change of the non-linear characteristic of the whole transmitter according to a comparison between the digital input signal and the HPA amplified radio frequency signal to control an operation of the predistortion unit.

2. The transmitter of claim 1, wherein the predistortion unit stores an initial value, which is the opposite to the non-linear characteristic of the whole transmitter, as a high degree function or in a look-up table form.

3. The transmitter of claim 2, wherein the predistortion unit updates a coefficient of the high degree function or the look-up table value under the control of the error detector.

4. The transmitter of claim 1, wherein the predistortion unit includes a direct IF up-converter and a predistorter.

5. The transmitter of claim 4, wherein the direct IF up-converter and the predistorter are implemented in one chip.

6. The transmitter of claim 1, wherein the predistortion unit comprises:
first and second pulse shaping filters (PSFs) that sample the digital input signal;
first and second interpolators that interpolate output signals of the first and second PSFs, respectively;
first and second predistorters that distort output signals of the first and second interpolators, respectively, to be opposite to the non-linear characteristic of the whole transmitter;
first and second converters that convert output signals of the first and second predistorters, respectively, into intermediate frequency signals according to first and second oscillation signals, respectively; and
an adder that synthesizes the output signals of the first and second up-converters.

7. The transmitter of claim 6, wherein the first and second oscillation signals have a phase difference of 90° to each other.

8. The transmitter of claim 1, wherein the predistortion unit comprises:
first and second pulse shaping filters (PSFs) that sample the digital input signal, respectively;
first and second interpolators that interpolate output signals of the first and second PSFs, respectively;
first and second up-converters that convert the output signals of the first and second interpolators into intermediate frequency signals according to first and second oscillation signals;
an adder that adds the output signals of the first and second up-converters; and
a predistorter that distorts the output signal of the adder to be opposite to the non-linear characteristic of the whole transmitter.

9. The transmitter of claim 1, wherein the radio frequency converter comprises:
a digital/analog converter (DAC) that converts the output signal of the predistortion unit into an analog signal;
a low pass filter (LPF) that filters the analog signal of the DAC; and
an up-converter that converts the filtered analog signal of the LPF into the radio frequency signal.

10. The transmitter of claim 1, wherein the error signal detector comprises:
a delay unit that delays the digital input signal;
a down-converter that converts the amplified radio frequency signal to an intermediate frequency signal; and
an analog/digital converter (ADC) that converts the intermediate frequency signal of the down-converter into a feedback digital signal, wherein
the error detector compares the delayed digital input signal and the intermediate frequency signal to detect a non-linear characteristic variation of the whole transmitter.

11. An adaptive predistortion transmitter, comprising:
a predistortion unit that predistorts a digital input signal, based on a control signal;
a radio frequency converter that converts the predistorted digital input signal into a radio frequency signal; and
an error signal detector that adaptively modulates the control signal based on the digital input signal and the radio frequency signal.

12. The transmitter of claim 11, wherein the error signal detector modulates the control signal to vary the predistortion applied to the digital input signal so that a non-linear characteristic of the amplified radio frequency signal introduced by the radio frequency converter is cancelled by signal addition in a subsequent portion of the radio frequency signal.

13. The transmitter of claim 11, further comprising:
a high powered amplifier (HPA) that amplifies the radio frequency signal, wherein
the error signal detector adaptively modulates the predistortion based on the digital input signal and the amplified radio frequency signal.

14. The transmitter of claim 13, wherein the error signal detector modulates the control signal to vary the predistortion applied to the digital input signal so that non-linear characteristics of the amplified radio frequency signal introduced by the radio frequency converter and the HPA are cancelled by signal addition in a subsequent portion of the amplified radio frequency signal.

15. The transmitter of claim 13, further comprising:
an intermediate frequency converter that converts the predistorted digital input signal to an intermediate frequency signal; and
a digital to analog converter that converts the intermediate frequency signal to an analog signal, wherein
the radio frequency converter converts the analog signal to the radio frequency signal, and
the error signal detector modulates the control signal to vary the predistortion applied to the digital input signal so that non-linear characteristics of the amplified radio frequency signal introduced by the intermediate frequency converter, the radio frequency converter, and the HPA are cancelled by signal addition in a subsequent portion of the amplified radio frequency signal.

16. The transmitter of claim 11, wherein the digital input signal is comprised of I and Q phases and each of the I and Q phases are separately predistorted by the predistortion unit before being combined by an adder, converted to an analog signal, and up-converted to the radio frequency signal.

17. The transmitter of claim 11, wherein the digital input signal is comprised of I and Q phases and the I and Q phases are combined into an intermediate frequency signal before being predistorted and converted to the radio frequency signal.

18. An adaptive predistortion transmission method, comprising:
predistorting a digital input signal based on a control signal;
converting the predistorted digital input signal into a radio frequency signal; and
adaptively modulating the control signal based on the digital input signal and the radio frequency signal, wherein
the control signal is modulated to vary the predistortion applied to the digital input signal so that a non-linear characteristic of the radio frequency signal, introduced by the conversion to radio frequency, is cancelled by signal addition in a subsequent portion of the radio frequency signal.

19. The method of claim 18, further comprising:
amplifying the radio frequency signal to a high power for wireless transmission, wherein
the control signal is modulated to vary the predistortion applied to the digital input signal so that a non-linear characteristic of the amplified radio frequency signal, introduced by the conversion to radio frequency and amplification, is cancelled by signal addition in a subsequent portion of the amplified radio frequency signal.

20. The method of claim 18, further comprising:
converting the predistorted digital input signal into an intermediate frequency signal before converting to the radio frequency signal, wherein
the control signal is modulated to vary the predistortion applied to the digital input signal so that a non-linear characteristic of the amplified radio frequency signal, introduced by the conversion to intermediate and radio frequency, is cancelled by signal addition in a subsequent portion of the radio frequency signal.
